(19) United States
(12) Patent Application Publication
(10) Pub. No.: US 2024/0379081 A1
(43) Pub. Date: Nov. 14, 2024

(54) SYSTEM AND METHOD FOR GENERATIVE AI-BASED MUSIC CREATION

(71) Applicant: BELLEVUE INVESTMENTS GmbH & Co. KGaA, BERLIN (DE)

(72) Inventors: DIETER REIN, BERLIN (DE); JURGEN JARON, BERLIN (DE)

(73) Assignee: BELLEVUE INVESTMENTS GmbH & Co. KGaA, BERLIN (DE)

(21) Appl. No.: 18/657,849

(22) Filed: May 8, 2024

Related U.S. Application Data
(60) Provisional application No. 63/464,678, filed on May 8, 2023.

(51) Int. Cl. G10H 1/00

(52) U.S. Cl. CPC G10H 1/0025; G10H 2210/105; G10H 2210/111; G10H 2220/101

(57) ABSTRACT

According to a first embodiment, there is presented herein an approach for a generative AI-based music creation system utilizing a user defined framework parameters containing at least one particular generative variable. A trained AI system with an associated audio loop database is used to generate multiple different output songs for selection by the user.

### CROSS REFERENCE TO RELATED APPLICATIONS

This application claims the benefit of U.S. Provisional Patent Application Ser. No. 63/464,678 filed on May 8, 2023, and incorporates said provisional application by reference into this document as if fully set out at this point.

### TECHNICAL FIELD

This disclosure relates generally to AI assisted methods of editing and generating audio content and, in more particular, to methods that involve a combination of machine learning in an AI based selection and definition engine for automatic song construction based on selections and definitions provided by a user.

### BACKGROUND

Creation of a musical work has been a goal and dream of many people for as long as music has been around. However, a lack of knowledge of details regarding the intricacies of music styles has prevented many from generating and writing music. As such, this endeavor has, for a very long time, been a privilege of people having the necessary knowledge and education.

With the advent of the personal computer and the widespread adoption of these devices in the home consumer market software, products have emerged that allow a user to create pleasing and useful musical compositions without having to know music theory or needing to understand music constructs such as measures, bars, harmonies, time signatures, key signatures, etc. These software products provide graphical user interfaces with a visual approach to song and music content that allow even novice users to focus on the creative process with easy access to the concept of music generation.

Additionally, these software products have simplified the provision of content available for the generation of music to the user. A multitude of individual sound clips, e.g., sound loops or just “loops”, are usually provided to the user for selection and insertion into the tracks of a graphical user interfaces. With these software products the task of music or song generation has come within reach for an expanded audience of users, who happily took advantage of the more simplified approach to music or song generation. These software products have evolved over the years, gotten more sophisticated and more specialized, some have even been implemented on mobile devices.

However, the general approach to music or song generation according to this approach has remained virtually unchanged, i.e., the user is required to select individual pre-generated loops that contain audio content representing different instruments, for example drums, bass, guitar, synthesizer, vocals, etc., and place them in digital tracks to generate individual song parts with a length of 4 or 8 measures. Using this approach most users are able to generate one or two of these song parts with the help of the graphical user interface of a mobile or desktop-based software product.

A complete song or a complete piece of music however typically needs at least two minutes of playtime with up to 16 individual song parts. To generate so many song parts with the necessary eye and enthusiasm for detail overstrains the patience and endurance of most users and these users capitulate and end the generation process prematurely and the song or music piece generated by these users ends as being too short or musically unsatisfying, ends as song or music piece fragments. Additionally to these problems on the creative and user side of the creation process a reoccurring stop in the creation process which is eventually leading to an abandonment of the software product is also not desirable regarding the business model of the software product, because the target and result of the workflow of the software product should be completed and result in musically good songs or music pieces, which in an associated online community are valued and liked and therewith make sure that the user of the software product is satisfied and continuing to use the software product.

Thus, what is needed is a method for enabling a user to complete the song or music piece generation process with a musically sound result, being a complete song or music piece, wherein a user is provided with an option to generate an individual framework for song creation by selecting at least one variable for song creation from a multitude of available variables. This framework is then utilized by a machine learning based AI system that by communicating and cooperating with an audio render engine and an associated audio content database automatically generates a plurality of audio files for examination, selection and refinement by the user.

Heretofore, as is well known in the media editing industry, there has been a need for an invention to address and solve the above-described problems. Accordingly, it should now be recognized, as was recognized by the present inventors, that there exists, and has existed for some time, a very real need for a system and method that would address and solve the above-described problems.

Before proceeding to a description of the present invention, however, it should be noted and remembered that the description of the invention which follows, together with the accompanying drawings, should not be construed as limiting the invention to the examples (or embodiments) shown and described. This is so because those skilled in the art to which the invention pertains will be able to devise other forms of this invention within the ambit of the appended claims.

### SUMMARY OF THE INVENTION

According to a first embodiment, there is presented here a generative music system using AI models. The generative music system allows a user to define a music creation framework that is being utilized by at least one selected AI model to generate a plurality of different output music works for selection by the user.

In some embodiments, the following general steps will be followed in a typical workflow.
a) The user will be required to select at least a genre and enter it into the song framework. Other parameters that are highly relevant are energy, instruments, and key.
b) A seed part will be generated by the AI system based on the framework parameters specified by the user in step (a).
   i) The seed part will be four bars of music, preferably not longer.
   ii) Audio loops will be selected from the audio loop database based on the seed part and the parameter specification in (a).
c) The AI system will generate a full song composition based on the selected audio loops using training data that has been previously stored in the system.
d) The full generated song will be played for the user.
   Steps (b) to (d) will happen immediately after the user enters the data in (a) so that the user gets a real time song generation experience.
e) At any point the user can add, remove, or change parameters that are stored in the framework and the AI system will generate a full song associated with the new parameters in real time for further review.

As a first specific example, if the user adds or modifies the song structure parameter, the AI system will reconfigure the sequence of audio loops or replace the audio loops presently in the music work to achieve the desired song structure. As a second example, if the user modifies the energy parameter, the AI engine will select and insert/remove the audio loops containing the desired energy, potentially enhance the number of audio loops stacked in the same bar of music, and/or change the type of instrumentation of the selected music items.

The foregoing has outlined in broad terms some of the more important features of the invention disclosed herein so that the detailed description that follows may be more clearly understood, and so that the contribution of the instant inventors to the art may be better appreciated. The instant invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

These and further aspects of the invention are described in detail in the following examples and accompanying drawings.

FIG. 1 is an illustration of a working environment of the instant invention according to an embodiment.

FIG. 2 depicts an example of a workflow of an embodiment of the instant invention.

FIG. 3 illustrates one plurality of selectable variables for the framework definition.

FIG. 4 illustrates a more detailed depiction of the potential variants of the genre variable of the instant invention.

FIG. 5 depicts different selectable variants of the energy variable of a variation of the instant invention.

FIG. 6 illustrates a selection of the potential variants of the key variable of the instant invention.

FIG. 7 depicts the sort of instrument selection that might be offered to a user in connection with the instrument variable.

FIG. 8 illustrates a selection of the potential variants of the mood variable of the instant invention.

FIG. 9 illustrates an approach to disclose a table as basis for chord progression combinations utilized as base for the chord progression variable of the instant invention

FIG. 10 discloses the selectable form of the chord progression variable of the instant invention.

FIG. 11 depicts the selectable variants of the song structures variable of the available framework definition of the instant invention.

FIG. 12 discloses a workflow suitable for use with the instant invention.

FIG. 13 illustrates one processing approach of an AI analysis server utilized by the instant invention.

FIG. 14 depicts a data structure that might be associated with any particular audio loop stored in an associated audio loop database suitable for use by the instant invention.

FIG. 15 illustrates a preferred workflow suitable for use with the instant invention.

### DETAILED DESCRIPTION

While this invention is susceptible of embodiment in many different forms, there is shown in the drawings, and will be described hereinafter in detail, some specific embodiments of the instant invention. It should be understood, however, that the present disclosure is to be considered an exemplification of the principles of the invention and is not intended to limit the invention to the specific embodiments or algorithms so described. It should be noted that similar technology is discussed in U.S. Pat. No. 11,232,773, the disclosure of which is fully incorporated herein by reference as if set out at this point.

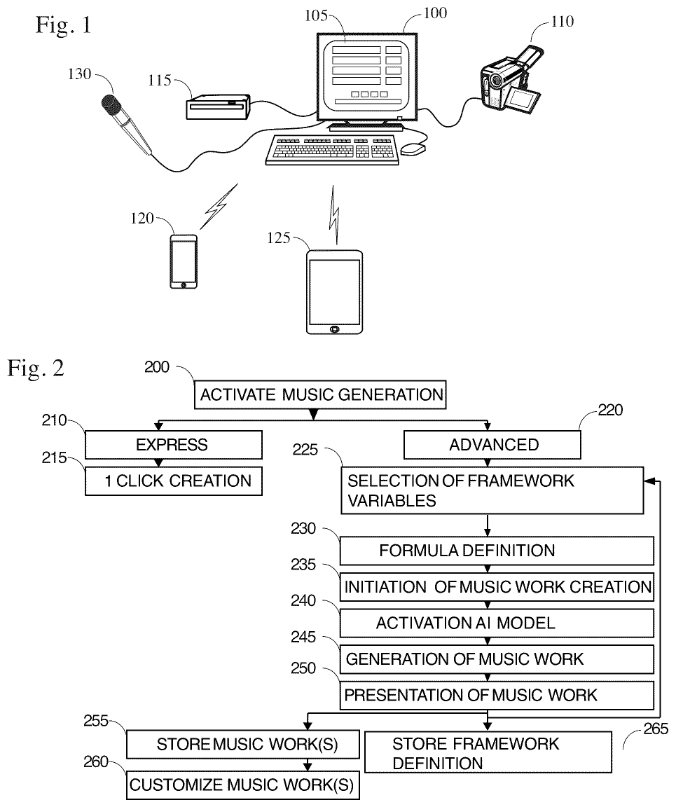

As is generally indicated in FIG. 1, at least a portion of the instant invention will be implemented in form of software 105 running on a user's computer 100 or another device with a CPU such as a tablet computer, smart phone, etc. For purposes of the instant disclosure, the word “computer” or CPU will be used generically to refer to any programmable device such as those listed in the previous sentence. Such a computer will have some amount of program memory and storage (whether internal or accessible via a network) as is conventionally utilized by such units. Additionally, it is possible that an external camera 110 of some sort might be utilized with—and will preferably be connectible to—the computer so that video, audio, and/or graphic information can be transferred to and from the computer. The cameras built into devices such as smart phones, table computers, etc., could also be used. Preferably the camera 110 in whatever form it takes will have digital video capabilities, although that is not a requirement, as it is contemplated that the user might wish to utilize still images from a digital still camera in the creation of his or her multimedia work. Further given the modern trend toward incorporation of cameras into other electronic components (e.g., in handheld computers, telephones, laptops, etc.) those of ordinary skill in the art will recognize that the camera might be integrated into the computer or some other electronic device and, thus, might not be a traditional single-purposes video or still camera. Although the camera will preferably be digital in nature, any sort of camera might be used, provided that the proper interfacing between it and the computer is utilized. Additionally, a microphone 130 might be utilized so that the user can add vocals to a musical work or a voice-over narration to a multimedia work. A digital media storage device 115 such as a DVD burner, external hard drive, SSD drive, etc., could be useful for storing in-progress or completed works. Of course, the storage device 115 might be accessible via a network or be situated in the cloud. Further, it might also be possible and is shown in FIG. 1 that the process of the instant invention might be implemented or accessed on portable tablet computer devices 125 or on mobile devices, such as smart phones 120.

Turning next to FIG. 2, this figure illustrates some of the principal workflow steps of an embodiment of the instant invention. The user, whether amateur, semi-pro or professional, begins by initiating the music generation process 200. Note that music generation, as that term is used herein, should be broadly construed to include generating audio content that comprises short or long music recordings of any type including audio recordings that may or may not be traditional songs with lyrics that are meant to be sung.

In a next preferred step, the user is provided with a choice between an express 210 form of music generation and an advanced 220 form of music generation. The express form of music generation provides an automated way to generate music works by using predefined templates which enable the user to produce a so called 1-click creation 215 of output material. This 1-click creation is a simplified approach which relieves the user of making many of the decisions that would otherwise need to be made as part of the music generation process.

The advanced 220 approach to music generation taught herein presents the user with a number of variables 225 that will be stored as a components of the music generation framework. The first step of the advanced process according to the instant invention is the selection of at least one of the framework variables or performance parameters 230. Note that for purposes of the instant disclosure the term “framework variables” is used to describe the collection of performance parameters that are fed as input to the AI step that follows. The instant invention will provide a fluid/continuous music generation process where the system will at least generate multiple output songs on the fly. As soon as the user specifies (adds, removes, or changes) a parameter value for a framework variable, the instant invention will modify (regenerate) the music that has been generated for the user accordingly.

In a next preferred step, the framework and its selected parameter values is utilized by the system to initiate the music work creation 235 process, wherein the instant invention will initiate a trained AI music work generation model 240 that receives as input the selected framework variable values. The AI model will then use the data obtained from the user and to generate at least one music work 245 that is then presented to the user 250. As the user is reviewing the currently generated work, a choice may be made to modify the parameters that created it. If so, the user will be provided the option to change a previously selected variable or select a new variable which will then result in a new music work being generated in real time. Thus, music works will be produced automatically and dynamically as the framework variables are added, subtracted, or changed. This will provide multiple output music works to the user as variables are changed or added and variable values are changed.

Note that, in some embodiments, the user will be able to select the particular AI system that is to be utilized. In that case, a number of different AI systems will be made available to the user for selection. In some embodiments a GAN AI model or a rule-based algorithmic learning model will be the default AI model although the user will be allowed to choose an alternative.

During the operation of the instant invention the user will be able to store the generated music works 255 for later review and potential further customization 260. Additionally, the user will be able to store the current contents of the framework 265, allowing the user to revisit the music work generation process and also share the framework with others, potentially creating a market for AI-based song frameworks.

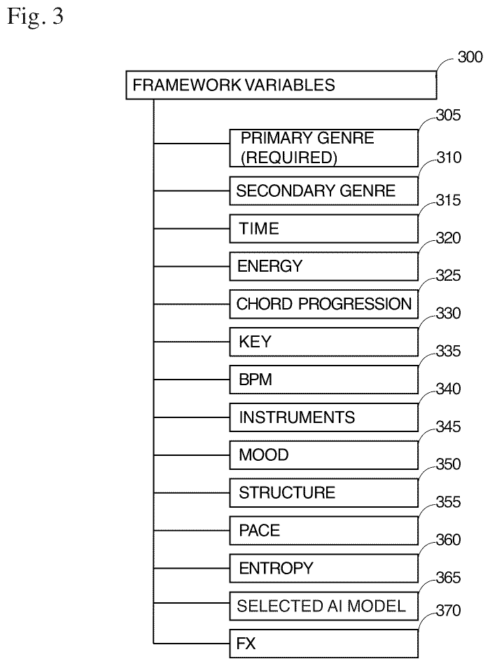

Coming next to FIG. 3, this figure discloses a list of preferred variables that might be used to define the framework 300, which variables are used to generate the music output files according to the instant invention, with a selection of a genre 305 being required. One or more of the options 310 to 370 in FIG. 3 may optionally also be selected. The user is able to select any number of the available options that represent individual characteristics of the desired output music work. In some embodiments, the user will be presented with the 14 variables listed in FIG. 3, although other arrangements are certainly possible.

As is indicated in FIG. 3, the user is required to at least select a desired primary genre 305 and the instant AI phase could proceed with only that value supplied. Optionally, though, the user can select additional variables and their associated parameter values. For example, the user can add a secondary genre 310 selection. The user might also select a time setting 315 that at least specifies the duration of the music work. Additionally, the user will be able to set the output energy level 320, pick a desired chord progression 325, set the key of the music work 330, define a preference range for the bpm (beats per minute) 335, select preferred instrument(s) 340, pick a mood setting 345, refine the song structure 350, set preferences for pace 355, choose AI model 365 and specify the sorts of FX that are to be applied to the output music work.

The pace 355 variable represents the frequency of chord/phrase transitions in the music item. A higher setting for pace leads to a more frequent change and a higher number of chord transitions which tends to give the feeling that the music item has more energy and is more dynamic. Changes in the values of the pace preference variable tends to lead to changes in bar composition and/or in the instrument transitions.

The entropy 360 variable might have values scaled to be between 1 and 10. For example, if a new drum loop is selected every four bars and the entropy 360 value is chosen to be 1, that will result in a stable and predictable drum sequence. On the other hand, if entropy has been set to 10 this will result in an unpredictable drum sequence or “maximum chaos”. The logic behind this variable is that increasing the entropy value increases the acceptable distance between successive audio loops that are being considered for inclusion in the music work, i.e., small values of entropy mean that the AI selection of loops will be limited to loops that are close to each other in multivariate space or, more generally, have characteristics that are similar to each other. On the other hand, larger values of entropy will open the door to selecting loops that are dissimilar to each other and, hence, expands the pool of selectable loops to the point that the chosen loops appear to be almost randomly selected. Large values of entropy can yield more interesting or experimental music item results.

FIG. 4 provides additional details regarding the parameter value choices associated with some of the variables in FIG. 3. First with respect to the primary genre 300, it should be noted that this parameter is “primary” only the sense that it is the first (and mandatory) parameter value that is specified by the user. As is indicated in FIG. 3, the user will also be allowed to selected a secondary genre. 310. By way of explanation, if a primary and a second genre are both selected by the user, the choice of a secondary genre will make it possible for the created music work to contain example passages of both genres. In the current example, the list of genres is the same for primary and secondary genre, e.g., in FIG. 4 the choices EDM 400, techno 405, house 410 and rock 415 would be available as selections for both primary and secondary genre. Of course, many other genre choices might be provided. The selected genre or, more generally, the selection of a specific variable and the genre value associated with that variable, will be used to guide the creation of the music work. These parameters assist the AI in selecting audio loops from an associated audio loops database to use in generating the music work.

In some embodiments, each loop in the database might have tags or metadata corresponding to the instrument type(s), the genre(s), the mood(s), the energy level(s), the key(s), and the BPM(s). In each case it should be noted a database loop might have more than any of the foregoing. For example, a loop might include a key change which would mean that it could be tagged with multiple keys. Finally, another tag that would be useful in some context would be a numerical value that is assigned by, for example, a convolutional neural network using audio deep signal processing and information retrieval. This parameter could prove to be useful when calculating the relational “distance” values between loops.

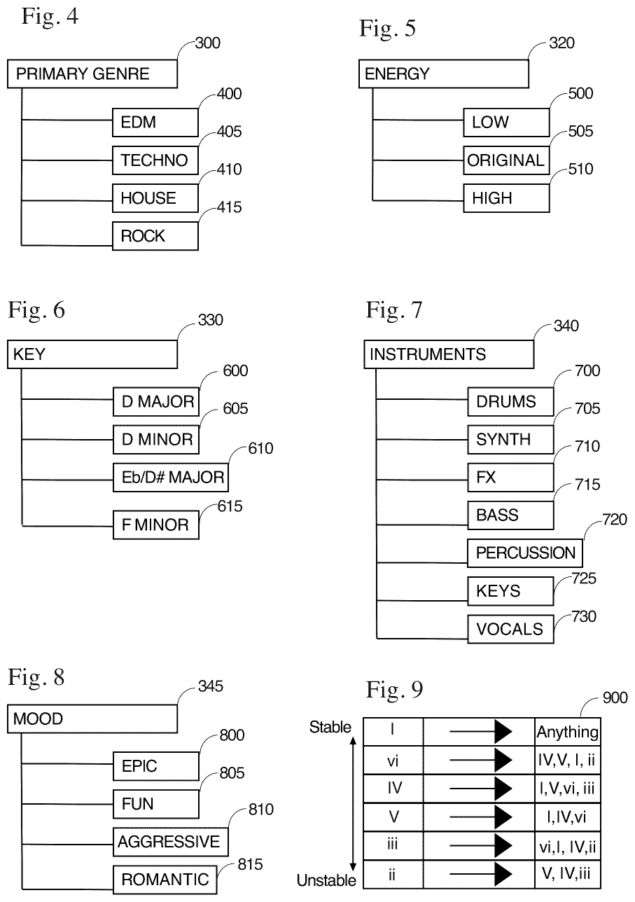

Coming next to FIG. 5, this figure depicts some possible different selectable parameter values of a music work energy variable 320. This variable specifies the desired energy level of the output music work. In the current example, the user is able to select the desired energy level of the output music work to be low 500, original 505 or high 510. In case where the user has selected the original energy 505 level, the system will leave the energy level of the audio loops unchanged. The system will adapt the audio loops in case the user selects either the low 500 or high 510 energy. This might be done by having AI engine select and insert/remove the audio loops that contain tags that indicate they match the desired energy level. The number of audio loops stacked in the same bar of music could also be enhanced, and/or the type of instrumentation of the selected music items could be changed. Any of these approaches could be used to modify the energy level of the output music work.

Turning next to FIG. 6, this figure illustrates some possible parameter choices that might be offered in connection with the key 330 variable. In this example, the user is provided with a list of different keys, for example D Major 600, D Minor 605, Eb/D #Major 610 and F Minor 615. Obviously, there are many other possible key choices and the keys in FIG. 6 represent an example of the sorts of key selections that might be presented to a user. The selection of a specific key, or in general the selection of a specific variable and the parameter values associated with this variable, communicates to the AI music generation system one of the more important values that will be used to guide the music generation system and will be used by the AI system to select audio loops from an associated audio loops database to generate the desired music work in real time or on-the-fly. This should not be inferred to rule out the possibility that the AI might transpose a loop from the database that is recorded in one key to the key choice of the user.

Coming next to FIG. 7, this figure depicts one possible instrument list 340 that might be presented to the user. In this particular variable list the user is provided with a number of different instruments, for example drums 700, synth 705, FX 710, bass 715, percussion 720, keys 725 and vocals 730. The user will be offered the option of selecting one or more instruments from the list. Of course, the instruments in FIG. 7 are presented for purposes of illustration only and it should be noted that any number of additional or different instruments might be offered to the user.

Turning next to FIG. 8, this figure illustrates some potential variants of the mood variable 345 which specifies the desired mood level of the music work. This variable, among others, is most often used in connection with initial setup and the defined parts of the music work, with the audio loops being selected accordingly. Among the sorts of moods that might be offered as parameter values to the user are epic 800, fun 805, aggressive 810 and romantic 815. Obviously, the instant invention should not be limited to the moods listed in this figure but, instead, it should be noted that the variants in FIG. 8 represent only one possible list and other arrangements that include more, fewer, or different choices are also possible. Also, the user might select more than one mood variant. If that is done, the framework will be adapted accordingly and, in the creation process, the system will select from the audio loops that have the selected mood value or values.

Coming next to FIG. 9, this figure contains a table that illustrates how various chord progressions can be classified as being relatively stable or unstable. A sequence of chords in a key is called a diatonic chord progression. This table 900 shows which chords sound best when appearing next to each other in a music work. Of course, chord transitions that are appealing to one country or civilization might not be appealing to another and table 900 has been chosen to reflect the preferences found in Western music. A chord can be used more than once in a progression and a strong progression starts or ends on a stable chord. Note that in this table lower case roman numerals correspond to minor chords and capital roman numerals correspond to major chords.

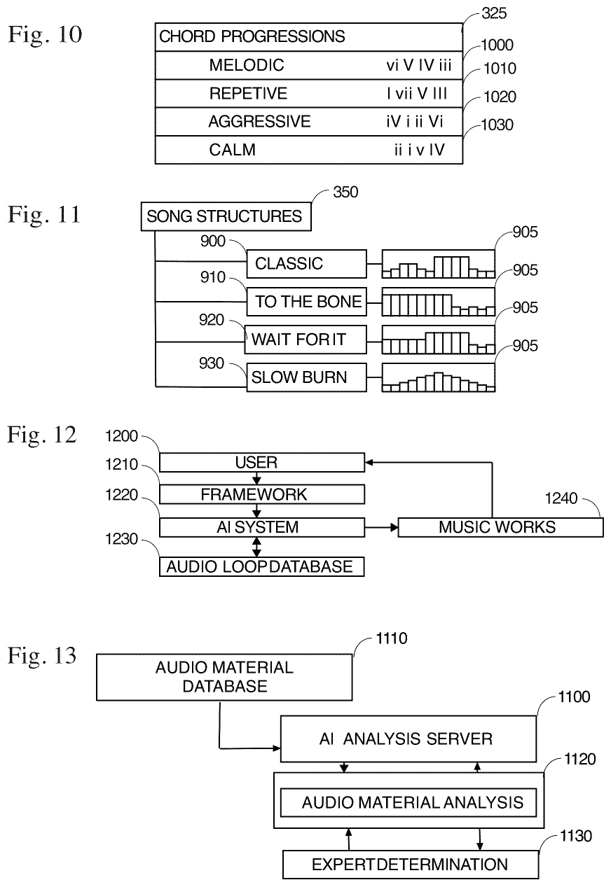

Turning next to FIG. 10, this figure discloses a possible selectable form of the chord progression variable 325, wherein a number of different chord progressions are provided for selection by the user, which progressions are preferably presented in two different forms. First, each chord progression will be given a descriptive name (i.e., melodic 1000, repetitive 1010, aggressive 1020, and calm 1030). Additionally, each chord progression contains details related to the chord pattern that is associated with that descriptive name (e.g., MELODIC is associated with the chord progression vi, V, IV, and iii, with lower case chords being indicative of a minor key).

Turning next to FIG. 11, this figure depicts some example variants of the song structures 350 variable. The different values are presented to the user primarily by a specific chosen name representing the feel of a potential music work, for example classic 900, to the bone 910, wait for it 920 and slow burn 930. The graphic 905 associated with each variant represents in a general way the volume changes of a potential output work over time. The graphic 905 has been given to assist the user in understanding the value associated with the selected song structure variable. Note that that the term “song structures” as it is used herein refers to templates that are applied during the music generation process and which deliver a set of rule variations into the composition process.

Turning next to FIG. 12, this figure discloses some important components of the workflow according to an embodiment. To start the process, the user 1200 selects the parameters that go into the framework 1210 and the framework is then provided to the AI system of the instant invention 1220. The user's parameter choices are then used to generate a music work 1240 on the fly by translating the framework contents into specific database requests. The selection criteria are then used to query to an associated and available audio loop database 1230. Finally, selected audio loops from that database are integrating into the structure of a music work and presented to the user. The user will then be allowed to further edit the framework contents and have a new music work generated accordingly.

Turning next to FIG. 13, this figure illustrates one possible processing and training methodology of the AI analysis server utilized by the instant invention. The songs in the audio material database 1310 are used to train the AI server 1300 to recognize music work structures and content in audio material. The AI analyzes 1320 the audio material stored in the audio material database 1310 and attempts to identify “good” music work structures. The results of this analysis are provided to an expert 1330 whose input is then provided as feedback to the AI analysis routine. This sort of feedback would be expected to elevate the quality of the AI analysis server results and the quality of the selection of the audio loops and the music work structures when implementing the defined framework variables.

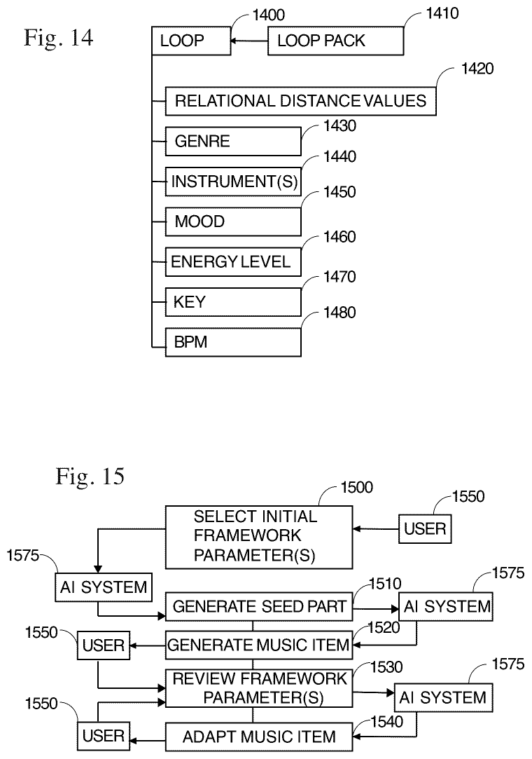

Turning next to FIG. 14, this figure illustrates a preferred data structure associated with the audio loops that are stored in an audio loop database of the sort that would be usable by the instant invention. The instant invention provides for and utilizes an evolving and growing database of audio loops, where the audio loops are categorized according to the instruments that are present in the loops. The loops will also preferably be organized in loop packs within the database, where “organized” should be broadly interpreted to include instances where the database can be searched to identify members of the loop packs. These loop packs can represent specific music styles for example EDM, 50's, Drum′n Bass, House, etc. However, these are only examples of the sorts of categories that might be used to organize the audio loops. Each loop pack features a one or more different instruments and associated audio loops. The database will be updated on a regular basis with new loop packs, wherein these updates are preferably being delivered over the Internet for free or in exchange for a particular payment option.

The system for machine-based learning in certain embodiments constantly monitors the available database of audio loops 1230. Of course, “constantly monitors” should be broadly interpreted to include periodic review of the database contents and/or notification that the content has changed. This is because, preferably, new content will be added to the database of audio loops regularly and the AI system will need to evaluate and analyses these new additions of audio loops.

The monitoring process will start after an initial analysis of the complete loop database 1230. After the initial analysis, the AI system will have information regarding every audio loop in the database for use during its real-time construction of the user's requested music item. Among the sorts of information that might be available for each loop are its auditory properties and affiliation with a particular loop pack 1410, genre 1430, instrument(s) 1440, mood 1450, energy level 1460, key 1470 and bpm 1480. Given this sort of information and utilization of the auditory properties for the selection of the audio loops, this embodiment provides the user with a wider bandwidth of audio loop selection independent of the confines of loop pack affiliation. Additionally, the AI system will also be able to work globally if so indicated by the user, i.e., the AI system will provide loop suggestions to a user that might not be contained in a local user audio loop database. If this option is selected, the completed music item will be provided to the user along with a notice which of the inserted audio loops are stored in the local database and which audio loops would have to be purchased.

According to one approach, the content of the loop database will be analyzed by an algorithm which could result as many as 200 of fundamental/low level auditory properties of an audio loop including, for example, its volume, loudness, the frequency content of the loop or sound (preferably based on its fast Fourier transform and/or its frequency spectrum) etc. However, to ease the computational load associated with building the user's music item, the dimensionality of the auditory properties for each loop will optionally and preferably be reduced to fewer summary parameters. In one preferred embodiment a further computation (e.g., principal component analysis (“PCA”), linear discriminant analysis (“LDA”), etc.) will be performed on the fundamental/low parameters to reduce their dimensionality. Methods of reducing dimensionality using PCA and LDA in a way to maximize the amount of information captured are well known to those of ordinary skill in the art. The resulting summary parameters which, in some embodiments might comprise at least eight or so parameters, will be used going forward. For purposes of the instant disclosure, the discussion will go forward assuming that the summary parameter count is “8”, although those of ordinary skill in the art will recognize that fewer or greater parameters might be used depending on the situation.

Continuing with the present example, with these 8 or so relational distance values 1420 the instant invention can generate an 8-dimensional mapping of the characteristics of each audio loop, with musically similar loops being positioned in the vicinity of each other in 8D space. This data might be stored in one database file and utilized by the machine learning AI as part of the process of an embodiment of the instant invention.

Coming next to FIG. 15, this figure illustrates one preferred workflow of the instant invention. The workflow of the instant invention preferably starts with the selection of an initial framework parameter 1500 which will be used in a general way to guide the creation of the user's music item. This parameter is the genre parameter. This parameter is selected by the user 1550. The selected framework parameter is provided to the associated machine learning AI system 1575 that utilizes the genre definition for the generation of a seed part 1510, the seed part being a song concept which typically would comprise 4 bars of music. The AI system will utilize the framework parameter and select relevant audio loops that match the selected criteria. Thus, the generated seed part will then automatically be selected by the AI system and a full music item composition 1520 will be generated and provided to the user for review.

An important aspect of the instant invention is that the framework is accessible and modifiable while the instant invention generates a music item. This means that the user can repeatedly change the contents of the framework-adding/removing/changing variables and variable values—and the AI system will monitor 1530 the changes in real time and immediately generate a new music item according to the modified parameters as they are changed. The user will then be immediately presented with the newly generated music item 1540.

Turning next to a discussion of the AI utilized herein, in some embodiment the AI might be a version of a deep learning “Generative Adversarial Net” (“GAN”). The AI will be given access to loops and/or incomplete music item projects stored in a training database, collectively “music items”. The music items in the database each include least one song part or track but may not be a complete music item. During the training phase, the AI will retrieve music items from the training database and will carry out an analysis of these items.

Before the start of the analysis, the training database items will preferably have been filtered (e.g., curated) to remove items that may not be good examples for training the AI. For example, music items whose structure, and associated loop selection exhibits too much randomness will be automatically discarded or discarded under the supervision of a subject matter expert. If the selected loops in the music item are too different from each other or if the loops “flip” back and both between successive song parts, e.g., if the internal consistency between song parts is too low, there is a high probability that this music item is not a good fit for the AI step that follows. The filtering process might also remove music items that use the same loops repeatedly or that seem to use an excessive number of loops (e.g., the item might be rejected if it either uses too many different loops or two few). Additionally, the filter might remove music items that are too similar to each other so that no one music item is given excessive weight because it occurs multiple times in the database. Database items that are not completed, e.g., that have empty tracks, gaps in the tracks, etc., will also preferably be eliminated. The filtering process is done to increase the probability that the remaining song items provide a good dataset for use by the AI system in the training step that follows.

Note that for purposes of the instant disclosure, in some embodiments a generated song project/music item will comprise 16 song parts (e.g., measures, groups of measures, etc.) each of which contain at least eight individual audio channels/tracks, so in this embodiment the result of the analysis will generate a data collection of at least 16 song parts each with eight channels containing the audio loops, with each audio loop being represented by 8 summary audio parameter values. The remaining song projects/music items constitute the pool which will be used in the AI training phase that follows.

Each song project/music item in the training database will preferably be converted to a 16×8×8 data array (i.e., 16 song parts, 8 audio channels, and 8 summary audio parameters) to allow the GAN AI to process it. The choice of the number of audio parameters and song parts is well within the ability of one of ordinary skill in art at the time the invention was made and might vary depending on the particular circumstances. This example including its dimensionality was only presented to make clearer one aspect of the instant invention.

As a next preferred step of the training process, the instant invention will be trained using training and validation datasets and use the numerical values calculated above and to develop an algorithmic recognition of what a music work should sound like. Given that information, the AI will be in a position to produce music items for the user using the loop database as input.

### CONCLUSIONS

Of course, many modifications and extensions could be made to the instant invention by those of ordinary skill in the art.

It should be noted and understood that the invention is described herein with a certain degree of particularity. However, the invention is not limited to the embodiment(s) set for herein for purposes of exemplifications, but is limited only by the scope of the attached claims.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

The singular shall include the plural and vice versa unless the context in which the term appears indicates otherwise.

If the specification or claims refer to “an additional” element, that does not preclude there being more than one of the additional elements.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

For purposes of the instant disclosure, the term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Still further, additional aspects of the instant invention may be found in one or more appendices attached hereto and/or filed herewith, the disclosures of which are incorporated herein by reference as if fully set out at this point.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A method of using an artificial intelligence (AI) system to construct a music work for a user, comprising the steps of:
(a) providing the user with a selectable list of framework variables;
(b) requiring the user to select a genre for the music work and an associated genre parameter value;
(c) optionally receiving from the user a selection of a first framework variable and a first parameter value associated therewith, said genre parameter value and said first parameter value, if any, together comprising a first parameter list;
(d) using said first parameter list and the AI system to generate a seed part;
(e) using at least the AI system, said first parameter list, and the seed part to generate a first music item for the user;
(f) performing at least a part of the first music item for the user;
(g) receiving from the user a selection of a second one of said framework variables and a second parameter value associated therewith, said genre parameter value, said first parameter value, if any, and said second parameter value together comprising a second parameter list;
(h) using the AI system, said second parameter list, and said seed part to generate a second music item for the user;
(i) performing at least a part of the second music item for the user; and
(j) repeating at least steps (g) through (i) until the user is satisfied with the second music item, said second music item comprising said constructed music work.

2. The method of using an artificial intelligence (AI) system to construct a music work for a user, wherein there is a first framework variable, and wherein said first framework variable and said second framework variable are a same framework variable and said first parameter value and said second parameter value are different parameter values.

3. A method of using an artificial intelligence (AI) system to construct a music work for a user, comprising the steps of:
(a) providing the user with a selectable list of framework variables;
(b) receiving from the user a selection of at least one first framework variable and a first parameter value associated therewith;
(c) using said selected at least one first parameter value and the AI system to generate a seed part;
(d) using at least the AI system and the seed part to generate a music item for the user;
(e) performing at least a part of the first music item for the user;
(f) receiving from the user another selection of a second one of said framework variables and a second parameter value associated therewith;
(g) using said selected at least second parameter values and the AI system to generate a second seed part;
(h) using the AI system and the second seed part to generate a second music item for the user;
(i) performing at least a part of the second music item for the user; and,
(j) repeating at least steps (f) through (i) until the user is satisfied with the second music item, said second music item comprising said constructed music work.
